(19) United States
(12) Patent Application Publication
(10) Pub. No.: US 2012/0092470 A1
(43) Pub. Date: Apr. 19, 2012

(54) STEREOSCOPIC DISPLAY DEVICE AND STEREOSCOPIC DISPLAY METHOD

(75) Inventor: Yoshiki Okamoto, Kanagawa (JP)

(73) Assignee: SONY CORPORATION, Tokyo (JP)

(21) Appl. No.: 13/271,413

(22) Filed: Oct. 12, 2011

(30) Foreign Application Priority Data
Oct. 19, 2010 (JP) 2010-234799

(51) Int. Cl. H04N 13/04

(52) U.S. Cl. 348/60; 348/E13.026

(57) ABSTRACT

A display device includes: a display unit that composes p (here, p is an integer equal to or greater than two) viewpoint videos that are spatially divided within one screen by sequentially displaying q (here, q is an integer that is equal to or greater than two and is equal to or less than p) display patterns that are divided in time; and an optical separation device that optically separates the p viewpoint videos configuring each one of the q display patterns displayed on the display unit.

### FIELD

The present disclosure relates to a stereoscopic display device and a stereoscopic display method capable of performing a stereoscopic display employing a parallax barrier system.

### BACKGROUND

Recently, display devices (stereoscopic display devices) that can realize a stereoscopic view have attracted attention. In the display of a stereoscopic view, a left-eye video and a right-eye video that are in parallax to each other (different viewpoints) are displayed. Thus, when an observer sees the left-eye video and the right-eye video with his or her left and right eyes, a stereoscopic video having depth can be recognized. In addition, display devices are developed which can provide an observer with a more natural stereoscopic video by displaying three or more videos in parallax to one another.

Such stereoscopic display devices can be largely divided into a type for which it is necessary to use dedicated glasses and a type for which it is unnecessary to use dedicated glasses. Since it is inconvenient for an observer to use the dedicated glasses, the type for which it is unnecessary to use the dedicated glasses (in other words, a type that can form a stereoscopic view for the naked eye) is more preferable. As stereoscopic display devices that can form a stereoscopic view for the naked eye, for example, stereoscopic display devices, for example, employing a parallax barrier system or a lenticular system are known. In the stereoscopic display device employing such a system, a plurality of videos (viewpoint videos) in parallax to one another are simultaneously displayed, and a video that is seen differs in accordance with the relative positional relationship (angle) between the display device and the viewpoint of an observer. In a case where a video having a plurality of viewpoints is displayed by the stereoscopic display device, the substantial resolution of the video becomes a resolution that is acquired by dividing the resolution of the display device such as a CRT (Cathode Ray Tube) or a liquid crystal display device by the number of viewpoints. Accordingly, here is a problem in that the image quality deteriorates.

In order to solve such a problem, various deliberations are made. For example, in JP-A-2005-157033, a method for equivalently improving the resolution is proposed in which a time-divisional display is performed by switching between a transmitting state and a shielding state of each barrier in a time-divisional manner in a parallax barrier system.

However, in a case where the parallax barrier extends in the screen vertical direction, although the resolution in the screen horizontal direction can be improved, it is difficult to improve the resolution in the screen vertical direction. Thus, as a technique for enhancing a balance (resolution balance) between the resolution in the screen horizontal direction and the resolution in the screen vertical direction, a step barrier system is developed. In such a step barrier system, the alignment direction (or extending direction) of openings of the parallax barrier or the axial direction of the lenticular lens is set to the diagonal direction of the screen, and one unit pixel is configured by a plurality of sub pixels of a plurality of colors (for example, R (red), G (green), and B (blue)) aligned in one row so as to be adjacent to the diagonal direction.

### SUMMARY

However, recently, improvement of the resolution together with improvement of the resolution balance regardless of the number of viewpoints is demanded.

Thus, it is desirable to provide a stereoscopic display device and a stereoscopic display method capable of suppressing deterioration of the resolution without degrading the resolution balance in a case where a stereoscopic display is performed using a plurality of viewpoint videos.

One embodiment of the present disclosure is directed to a display device including: a display unit that composes p (here, p is an integer equal to or greater than two) viewpoint videos that are spatially divided within one screen by sequentially displaying q (here, q is an integer that is equal to or greater than two and is equal to or less than p) display patterns that are divided in time; and an optical separation device that optically separates the p viewpoint videos configuring each one of the q display patterns displayed on the display unit. Here, the display unit includes a plurality of unit pixels each formed from a plurality of sub pixels displaying r types (here, r is an integer equal to or greater than three) of colors necessary for a color video display, the sub pixels of different colors are arranged in a same row in a screen horizontal direction and in a same row in a first direction other than the screen horizontal direction, and the sub pixels of a same color are arranged in a same row in a second direction other than both the screen horizontal direction and the first direction. In addition, the q display patterns are formed by displaying two consecutive sub pixel rows formed from the plurality of the sub pixels aligned in the first direction a plurality of times at a period of (p×2) rows in the screen horizontal direction. Each one of the unit pixels is configured by r types of the sub pixels selected from two or more and (r−1) or less consecutive rows extending in the screen horizontal direction, and the q display patterns composed within one screen are disposed at positions at which the unit pixels corresponding to each other overlap each other when the display patterns are relatively moved in parallel in the screen horizontal direction. The optical separation device, for example, is a variable-type parallax barrier that includes a plurality of light transmitting portions that transmit light output from the display unit or light traveling toward the display unit and a plurality of light shielding portions that shield the light output from the display unit or the light traveling toward the display unit and is configured such that arrangement states of the plurality of light transmitting portions and the plurality of light shielding portions can be changed in accordance with the q display patterns.

Another embodiment of the present disclosure is directed to a display method including: composing p (here, p is an integer equal to or greater than two) viewpoint videos that are spatially divided within one screen of a display unit by sequentially displaying q (here, q is an integer that is equal to or greater than two and is equal to or less than p) display patterns that are divided in time; and optically separating the p viewpoint videos configuring each one of the q display patterns displayed on the display unit by using an optical separation device. Here, a unit is used as the display unit in which a plurality of unit pixels each formed from a plurality of sub pixels displaying r types (here, r is an integer equal to or greater than three) of colors necessary for a color video display are included, the sub pixels of different colors are arranged in a same row in a screen horizontal direction and in a same row in a first direction other than the screen horizontal direction, and the sub pixels of a same color are arranged in a same row in a second direction other than both the screen horizontal direction and the first direction. In addition, the q display patterns are formed by displaying two consecutive sub pixel rows formed from the plurality of the sub pixels aligned in the first direction a plurality of times at a period of (p×2) rows in the screen horizontal direction, and each one of the unit pixels is configured by r types of the sub pixels selected from two or more and (r−1) or less consecutive rows extending in the screen horizontal direction. Furthermore, the q display patterns are disposed at positions for which the unit pixels corresponding to each other overlap each other when the display patterns are relatively moved in parallel in the screen horizontal direction. As the optical separation device, for example, a variable-type parallax barrier may be used, which includes a plurality of light transmitting portions that transmit light output from the display unit or light traveling toward the display unit and a plurality of light shielding portions that shield the light output from the display unit or the light traveling toward the display unit and is configured such that arrangement states of the plurality of light transmitting portions and the plurality of light shielding portions can be changed in accordance with the q display patterns.

According to the display device and the display method of the embodiments described above, in a case where a stereoscopic display is performed by using a plurality of viewpoint videos, each one of the unit pixels is configured by r types of the sub pixels selected from two or more and (r−1) or less consecutive rows extending in the screen horizontal direction. Accordingly, deterioration of the resolution in the screen vertical direction is suppressed. In addition, since the unit pixels corresponding to each other in the plurality of display patterns are located at positions overlapping each other when the display patterns are relatively moved in parallel in the screen horizontal direction, deterioration of the resolution in the screen horizontal direction is suppressed.

Still another embodiment of the present disclosure is directed to a display device including: a display unit that displays p (here, p is an integer equal to or greater than two) viewpoint videos; and an optical separation device that optically separates the p viewpoint videos displayed on the display unit such that a stereoscopic view at the p viewing points can be formed. Here, the display unit includes a plurality of unit pixels each formed from a plurality of sub pixels displaying r types (here, r is an integer equal to or greater than three) of colors necessary for a color video display, the sub pixels of different colors are arranged in a same row in a screen horizontal direction and in a same row in a first direction other than the screen horizontal direction, and the sub pixels of a same color are arranged in a same row in a second direction other than both the screen horizontal direction and the first direction. In addition, the p viewpoints videos are formed by displaying two consecutive sub pixel rows formed from the plurality of the sub pixels aligned in the first direction a plurality of times at a period of (p×2) rows in the screen horizontal direction. Furthermore, each one of the unit pixels is configured by r types of the sub pixels selected from two or more and (r−1) or less consecutive rows extending in the screen horizontal direction. The optical separation device, for example, is a parallax barrier that includes a plurality of light transmitting portions that transmit light output from the display unit or light traveling toward the display unit and a plurality of light shielding portions that shield the light output from the display unit or the light traveling toward the display unit.

Yet another embodiment of the present disclosure is directed to a display method including: displaying p (here, p is an integer equal to or greater than two) viewpoint videos on a display unit; and optically separating the p viewpoint videos displayed on the display unit by using an optical separation device. Here, as the display unit, a unit is used in which a plurality of unit pixels each formed from a plurality of sub pixels displaying r types (here, r is an integer equal to or greater than three) of colors necessary for a color video display are included, the sub pixels of different colors are arranged in a same row in a screen horizontal direction and in a same row in a first direction other than the screen horizontal direction, and the sub pixels of a same color are arranged in a same row in a second direction other than both the screen horizontal direction and the first direction. In addition, the p viewpoints videos are formed by displaying two consecutive sub pixel rows formed from the plurality of the sub pixels aligned in the first direction a plurality of times at a period of (p×2) rows in the screen horizontal direction, and each one of the unit pixels is configured by r types of the sub pixels selected from two or more and (r−1) or less consecutive rows extending in the screen horizontal direction. As the optical separation device, for example, a parallax barrier may be used, which includes a plurality of light transmitting portions that transmit light output from the display unit or light traveling toward the display unit and a plurality of light shielding portions that shield the light output from the display unit or the light traveling toward the display unit.

According to the display device and the display method of the embodiments described above, in a case where a stereoscopic display is performed by using a plurality of viewpoint videos, each one of the unit pixels is configured by r types of the sub pixels selected from two or more and (r−1) or less consecutive rows extending in the screen horizontal direction. Accordingly, deterioration of the resolution in the screen vertical direction is suppressed.

Still yet another embodiment of the present disclosure is directed to a display device including: a display unit that sequentially displays p (here, p is an integer equal to or greater than two) viewpoint videos that are spatially divided in q (here, q is an integer that is equal to or greater than two and is equal to or less than p) display patterns that are divided in time; and an optical separation device that optically separates the p viewpoint videos. Here, the display unit includes a plurality of unit pixels each formed from r types (here, r is an integer equal to or greater than three) of sub pixels selected from two or more and (r−1) or less consecutive rows extending in a screen horizontal direction, and the q display patterns are disposed at positions for which the unit pixels corresponding to each other overlap each other when the display patterns are relatively moved in parallel in the screen horizontal direction.

According to the display device of the embodiment described above, in a case where a stereoscopic display is performed by using a plurality of viewpoint videos, each one of the unit pixels is configured by r types of the sub pixels selected from two or more and (r−1) or less consecutive rows extending in the screen horizontal direction. Accordingly, deterioration of the resolution in the screen vertical direction is suppressed. In addition, since the unit pixels corresponding to each other in the plurality of display patterns are located at positions overlapping each other when the display patterns are relatively moved in parallel in the screen horizontal direction, deterioration of the resolution in the screen horizontal direction is suppressed.

Further another embodiment of the present disclosure is directed to a display device including: a display unit that displays a plurality of viewpoint videos that are spatially divided; and an optical separation device that optically separates the plurality of viewpoint videos. Here, the display unit includes a plurality of unit pixels each includes three sub pixels selected from two consecutive rows extending in a screen horizontal direction, and the plurality of viewpoint videos are disposed at positions for which the unit pixels corresponding to each other overlap each other when the viewpoint videos are relatively moved in parallel in the screen horizontal direction.

According to the display device of the embodiment described above, in a case where a stereoscopic display is performed by using a plurality of viewpoint videos, each one of the unit pixel is configured by r types of the sub pixels selected from two or more and (r−1) or less consecutive rows extending in the screen horizontal direction. Accordingly, deterioration of the resolution in the screen vertical direction is suppressed.

According to the display devices of the one and still another embodiments and the method of the another embodiment, in a case where a stereoscopic display is performed by using so-called a parallax barrier system or the like, each one of the unit pixels is configured by r types of the sub pixels selected from two or more and (r−1) or less consecutive rows extending in the screen horizontal direction. Accordingly, the resolution in the screen vertical direction at each of the plurality of viewpoint videos can be improved. In addition, a plurality of display patterns having an overlapping relationship when being relatively moved in parallel in the screen horizontal direction are displayed in a time-divisional manner. Accordingly, the resolution in the screen horizontal direction at each of the plurality of viewpoint videos can be improved. Here, by appropriately selecting the types of colors of the sub pixels, the number of viewpoint videos, and the number of the display patterns, a balance between the resolution in the screen vertical direction and the resolution in the screen horizontal direction can be improved.

According to the display devices of the still another and further another embodiments and the display method of the yet another embodiment, in a case where a stereoscopic display is performed by using so-called a parallax barrier system or the like, each one of the unit pixels is configured by r types of the sub pixels selected from two or more and (r−1) or less consecutive rows extending in the screen horizontal direction. Accordingly, the resolution in the screen vertical direction at each of the plurality of viewpoint videos can be improved. Here, by appropriately selecting the types of colors of the sub pixels and the number of viewpoint videos, a balance between the resolution in the screen vertical direction and the resolution in the screen horizontal direction can be improved.

### BRIEF DESCRIPTION OF THE DRAWINGS

FIG. 1 is a configuration diagram illustrating the configuration of a stereoscopic display device according to a first embodiment of the present disclosure.

FIG. 2 is a block diagram illustrating circuits, which relate to display control, of the stereoscopic display device according to the first embodiment.

FIG. 3 is a plan view illustrating a sub pixel arrangement of a liquid crystal display panel of the stereoscopic display device according to the first embodiment.

FIG. 4 is a plan view illustrating an example of a first display pattern that is displayed on the liquid crystal display panel according to the first embodiment.

FIG. 5 is a plan view illustrating an example of a second display pattern that is displayed on the liquid crystal display panel according to the first embodiment.

FIGS. 6A and 6B are plan views illustrating examples of first and second barrier patterns that are formed on a switching liquid crystal panel according to the first embodiment.

FIGS. 7A and 7B are diagrams schematically illustrating the states of stereoscopic views in first and second display periods.

FIG. 8 is a plan view illustrating the arrangement pattern of sub pixels that are visually recognized by a right eye in the first display period.

FIG. 9 is a plan view illustrating the arrangement pattern of sub pixels that are visually recognized by a right eye in the second display period.

FIG. 10 is a plan view illustrating a composite video that is recognized as a first viewpoint video according to the first embodiment.

FIG. 11 is a plan view illustrating the sub pixel arrangement of the liquid crystal display panel of the stereoscopic display device according to the second embodiment.

FIG. 12 is a plan view illustrating an example of the first display pattern that is displayed on the liquid crystal display panel according to the second embodiment.

FIG. 13 is a plan view illustrating an example of the second display pattern that is displayed on the liquid crystal display panel according to the second embodiment.

FIGS. 14A and 14B are plan views illustrating examples of the first and second barrier patterns that are formed on the switching liquid crystal panel according to the second embodiment.

FIG. 15 is a plan view illustrating a composite video that is recognized as a first viewpoint video according to the second embodiment.

FIG. 16 is a feature diagram illustrating the relationship between the number of viewpoints and a resolution balance of the stereoscopic display device according to examples of the present disclosure.

### DESCRIPTION OF THE PREFERRED EMBODIMENTS

Hereinafter, embodiments of the present disclosure (hereinafter, referred to as embodiments) will be described in detail with reference to the accompanying drawings.

### First Embodiment

### [Configuration of Stereoscopic Display Device]

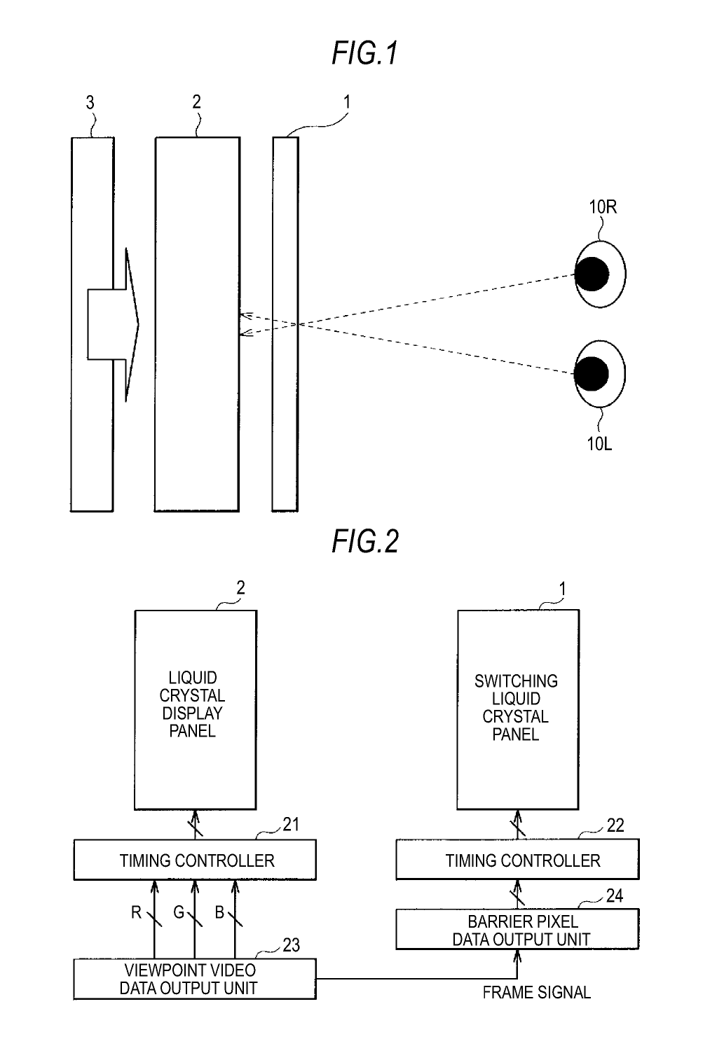

FIG. 1 illustrates the entire configuration of a stereoscopic display device according to a first embodiment of the present disclosure. FIG. 2 illustrates circuits, which relate to display control, of the stereoscopic display device. This stereoscopic display device, as illustrated in FIG. 1, includes a liquid crystal display panel 2, a back light 3 that is arranged on the rear side of the liquid crystal display panel 2, and a switching liquid crystal panel 1 that is arranged so as to face the display face side of the liquid crystal display panel 2. In addition, this stereoscopic display device, as illustrated in FIG. 2, includes a timing controller 21 that is used for controlling the display operation of the liquid crystal display panel 2 and a viewpoint video data output unit 23. Furthermore, the stereoscopic display device includes a timing controller 22 that is used for controlling the switching operation of the switching liquid crystal panel 1 and a barrier pixel data output unit 24.

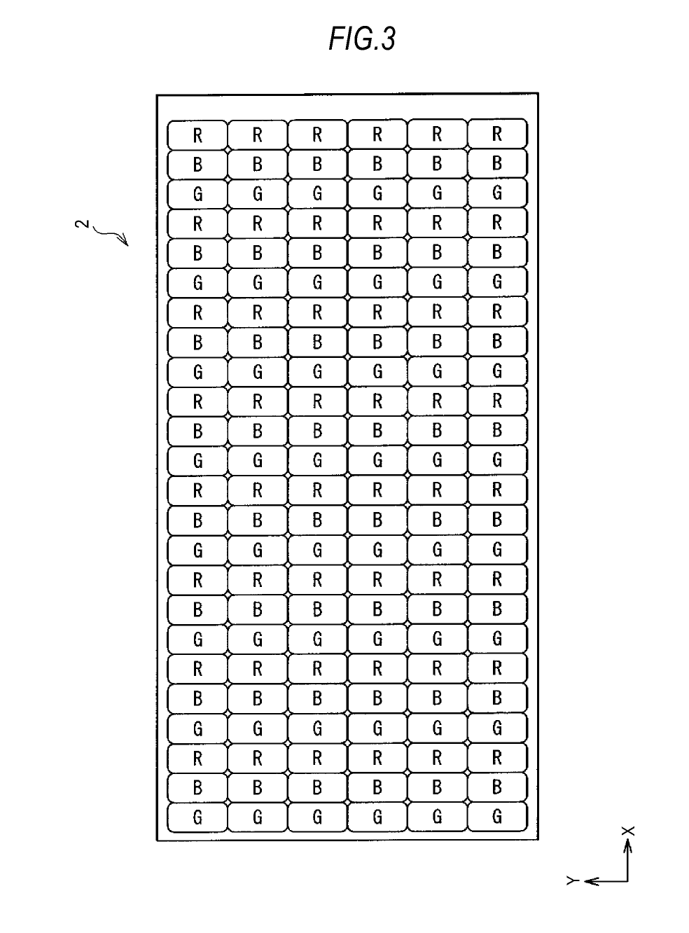

FIG. 3 illustrates an example of the sub pixel arrangement of the liquid crystal display panel 2. The liquid crystal display panel 2 has a pixel structure in which a plurality of sub pixels of three colors including R (red), G (green), and B (blue) that are necessary for a color display are two dimensionally arranged. As illustrated in FIG. 3, a pixel arrangement is formed in which a sub pixel of each color periodically appears in the same row in the screen horizontal direction (X-axis direction), and sub pixels of the same color are aligned in the same row in the screen vertical direction (the Y-axis direction). The liquid crystal display panel 2 having such a pixel structure modulates light emitted from the back light 3 for each sub pixel, and thereby performing a two-dimensional image display. The liquid crystal display panel 2 displays parallax images for a stereoscopic display that are output from the viewpoint video data output unit 23 under the control of the timing controller 21.

In addition, in order to realize a stereoscopic view, different viewpoint videos are necessarily seen by a left eye 10L and a right eye 10R. Accordingly, at least two viewpoint videos for a right-eye video and a left-eye video are necessary. In a case where three or more viewpoint videos are used, a multi-eye view can be realized. In this embodiment, a case will be described in which four viewpoint videos (first to fourth viewpoint videos) are formed (in other words, the number of viewpoints is four), and observation is performed by using two viewpoint videos (here, the first and second viewpoint videos) out of them.

In the liquid crystal display panel 2, four viewpoint videos including view point videos for the right eye (the first viewpoint) and the left eye (the second viewpoint) are spatially divided, and q (here, q is an integer that is equal to or greater than two and is equal to or less than p) display patterns that are divided in time are sequentially displayed, whereby the four viewpoint videos and the q display patterns are composed so as to be displayed within one screen. Here, the liquid crystal display panel 2 alternately displays (time-division display) two types of display patterns, whereby the display positions of the four viewpoint videos are periodically switched between two states. Image data corresponding to each display pattern is output from the viewpoint video data output unit 23. Here, timing for displaying each display pattern is controlled by the timing controller 21.

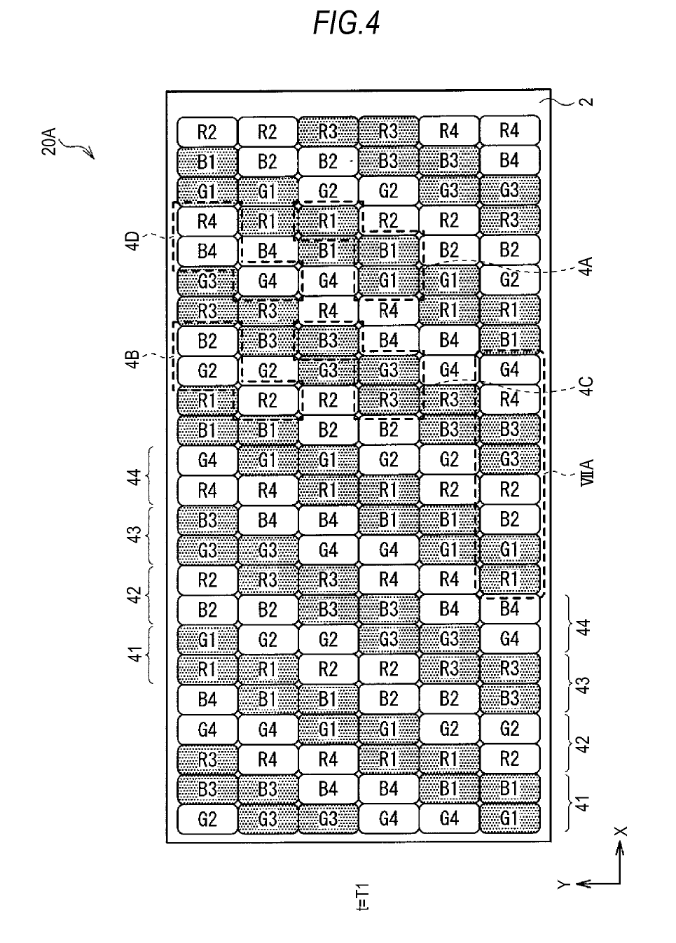

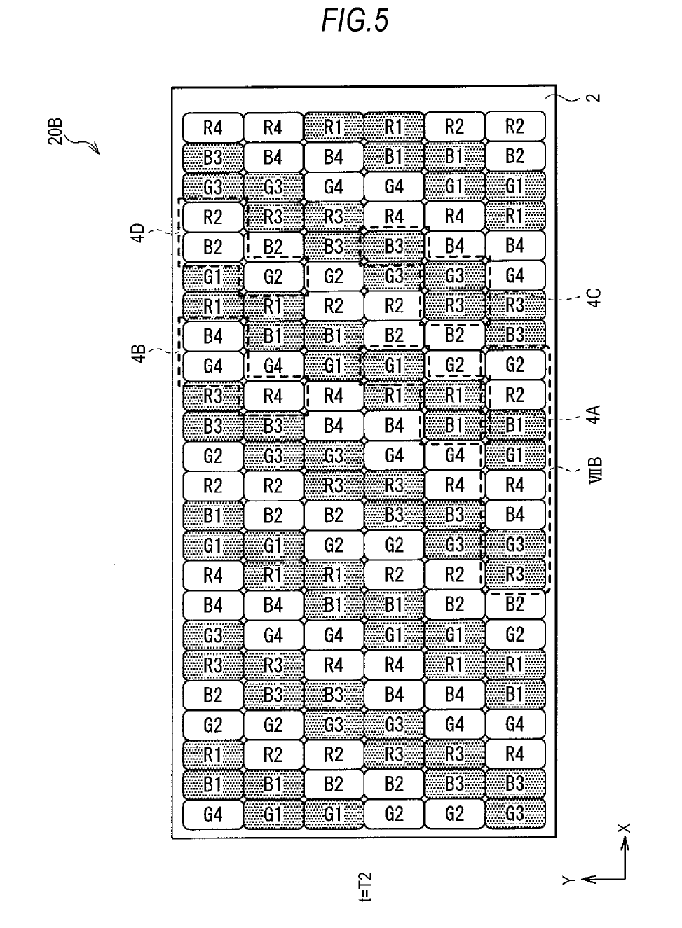

FIGS. 4 and 5 illustrate first and second display patterns 20A and 20B as examples of two types of display patterns that are displayed in a time-division manner. In the first and second display patterns 20A and 20B, first to fourth sub pixel groups 41 to 44 extend in a diagonal direction so as to be parallel to each other and are periodically arranged in order in the screen horizontal direction. The first sub pixel group 41 includes two consecutive sub pixel rows that are formed from a plurality of sub pixels, to which reference numerals R1, G1, and B1 are assigned, aligned in the diagonal direction. Similarly, the second sub pixel group 42 includes two consecutive sub pixel rows that are formed from a plurality of sub pixels, to which reference numerals R2, G2, and B2 are assigned, aligned in the diagonal direction. The third sub pixel group 43 includes two consecutive sub pixel rows that are formed from a plurality of sub pixels, to which reference numerals R3, G3, and B3 are assigned, aligned in the diagonal direction. In addition, the fourth sub pixel group 44 includes two consecutive sub pixel rows that are formed from a plurality of sub pixels, to which reference numerals R4, G4, and B4 are assigned, aligned in the diagonal direction. The first to fourth sub pixel groups 41 to 44 display the first to fourth viewpoint videos. In addition, in FIGS. 4 and 5, for easy identification, hatching is applied to the sub pixel rows of the first and third sub pixel groups 41 and 43 for convenience sake.

Here, one unit pixel that displays each one of the first to fourth viewpoint videos is configured by sub pixels of three colors R, G, and B selected from two consecutive rows extending in the screen horizontal direction. For example, as illustrated in FIGS. 4 and 5, a unit pixel 4A that displays the first viewpoint video (for example, a video for the right eye) is configured by a sub pixel G1 and a sub pixel B1 that are arranged in the same row extending in the screen horizontal direction and a sub pixel R1 that is present in a row adjacent to the row. Similarly, sub pixels R2, G2, and B2 are constituent elements of a unit pixel 4B that displays the second viewpoint video (for example, a video for the left eye). In addition, a unit pixel 4C that is configured by sub pixels R3, G3, and B3 configures the third viewpoint video, and a unit pixel 4D that is configured by sub pixels R4, G4, and B4 configures the fourth viewpoint video. As a result, the stripe-shaped first to fourth viewpoint videos extending in the screen diagonal direction are periodically arranged in the screen horizontal direction.

In the first display pattern 20A illustrated in FIG. 4 and the second display pattern 20B illustrated in FIG. 5, the positions of the unit pixels displaying the first to fourth viewpoint videos are different from each other. For example, the unit pixel 4A that is formed by the sub pixels R1, G1, and B1 to which the first viewpoint video is assigned in the first display pattern 20A becomes the unit pixel 4C formed from the sub pixels R3, G3, B3 to which the third viewpoint video is assigned in the second display pattern 20B. Similarly, the unit pixels 4B, 4C, and 4D to which the second, third, and fourth viewpoint videos are assigned in the first display pattern 20A become the unit pixels 4D, 4A, and 4B to which the fourth, first, and second viewpoint videos are assigned in the second display pattern 20B.

The switching liquid crystal panel 1 includes a plurality of pixels that are two dimensionally arranged and can perform a switching operation of switching between a light transmitting state and a non-light transmitting state for each pixel. The switching liquid crystal panel 1 realizes the function of a variable-type parallax barrier. The switching liquid crystal panel 1 forms a barrier pattern that is used for optically separating parallax images displayed on the liquid crystal display panel 2 for enabling a stereoscopic view. The switching liquid crystal panel 1 forms two types of barrier patterns corresponding to the first and second display patterns 20A and 20B illustrated in FIGS. 4 and 5 by periodically switching between two states.

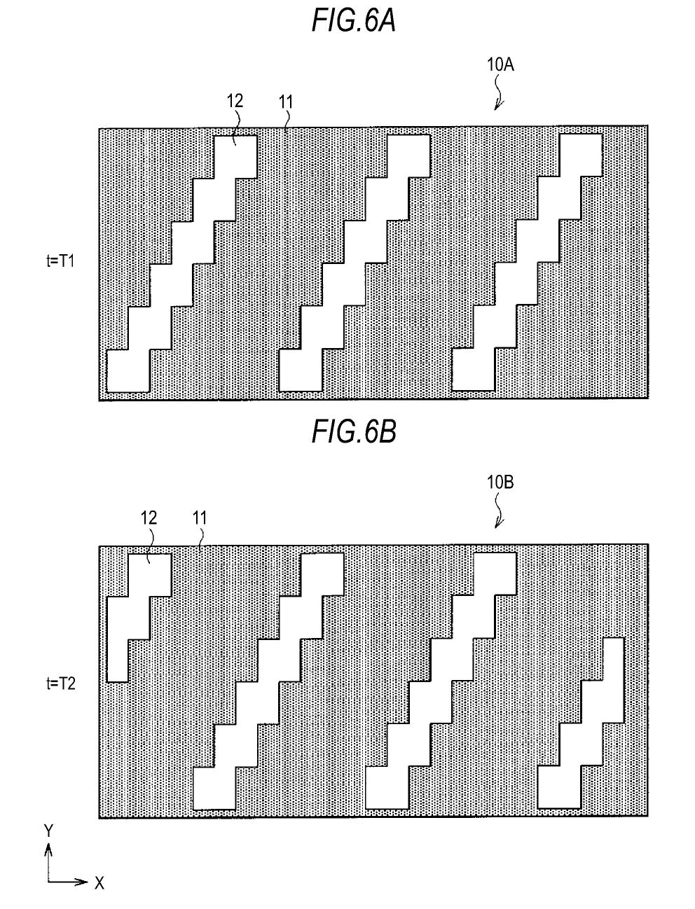

FIGS. 6A and 6B illustrate examples of the two barrier patterns (the first and second barrier patterns 10A and 10B). Each one of the first and second barrier patterns 10A and 10B is a pattern that is formed by a shielding portion (light shielding portion) 11 that shield display image light transmitted from the liquid crystal display panel 2 and openings (light transmitting portions) 12 that transmits the display image light. FIG. 6A is a first barrier pattern 10A corresponding to the first display pattern 20A illustrated in FIG. 4, and FIG. 6B is a second barrier pattern 10B corresponding to the second display pattern 20B illustrated in FIG. 5. In other words, the first barrier pattern 10A optically separates the display image light so as to enable a stereoscopic view when each viewpoint video is displayed in the first display pattern 20A. On the other hand, the second barrier pattern 10B optically separates the display image light so as to enable a stereoscopic view when each viewpoint video is displayed in the second display pattern 20B. The arrangement position and the shape of the opening 12 in the first and second barrier patterns 10A and 10B are set such that light of different viewpoint videos are separately incident to the left and right eyes 10L and 10R of an observer when the observer views the stereoscopic display device from a predetermined position in a predetermined direction. In addition, in FIGS. 6A and 6B, the opening 12 has a stepped shape extending in the diagonal direction in correspondence with the first to fourth sub pixel groups 41 to 44.

The pixel data used for forming the first and second barrier patterns 10A and 10B on the switching liquid crystal panel 1 is output from the barrier pixel data output unit 24. In addition, timing (timing for switching between a state in which light emitted from each sub pixel is transmitted and a state in which the light is not transmitted) for forming each barrier pattern in the switching liquid crystal panel 1 is controlled by the timing controller 22. The image data of each display pattern displayed on the liquid crystal display panel 2 is output from the viewpoint video data output unit 23, and, at this time, a frame signal acquired when each display pattern is changed is output to the timing controller 22 through the barrier pixel data output unit 24. The timing controller 22 performs control based on the frame signal such that the timing for changing each barrier pattern is synchronized with the timing for changing each display pattern on the liquid crystal display panel 2.

### [Operation of Stereoscopic Display Device]

According to this stereoscopic display device, on the liquid crystal display panel 2, each viewpoint video is displayed in the first and second display patterns 20A and 20B within one screen in a spatially divided manner, and the first and second display patterns 20A and 20B are periodically changed so as to be displayed. In other words, each viewpoint video is divided in space and time so as to be displayed on the liquid crystal display panel 2. On the switching liquid crystal panel 1, the first and second barrier patterns 10A and 10B are periodically formed so as to enable a stereoscopic view in synchronization with the switching between the first and second display patterns 20A and 20B.

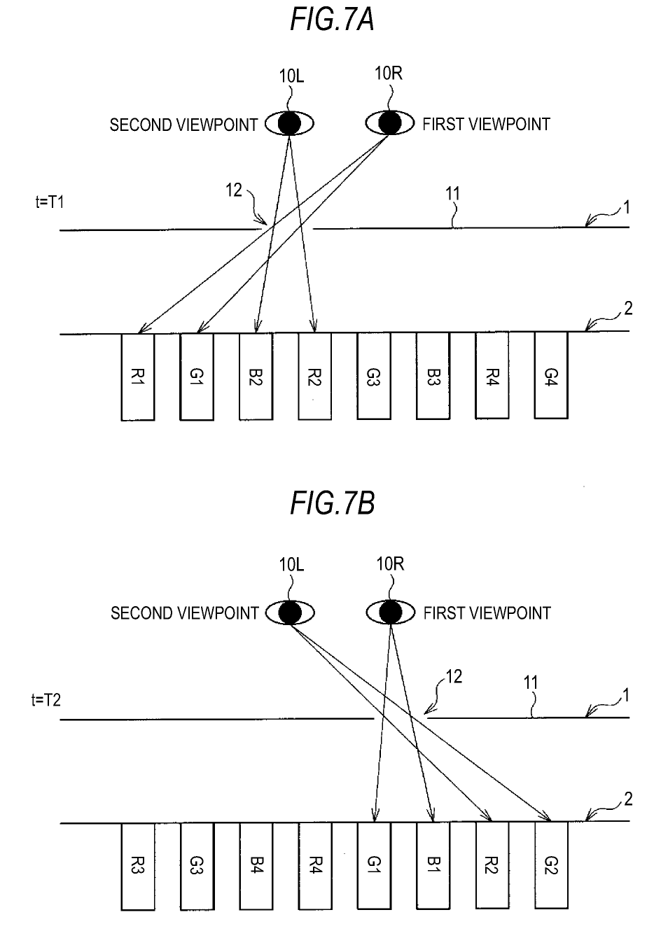

FIG. 7A schematically illustrates the state of a stereoscopic view in a first display period T1 in the stereoscopic display device. FIG. 7B schematically illustrates the state of a stereoscopic view in a second display period T2 that is different from the first display period T1. Here, it is preferable that both the first and second display periods T1 and T2 are equal to or less than 1/60 seconds (60 Hz or higher). In the first display period T1, the first display pattern 20A (FIG. 4) is displayed on the liquid crystal display panel 2, and the first barrier patterns 10A (FIG. 6A) is formed by the switching liquid crystal panel 1. On the other hand, in the second display period T2, the second display pattern 20B (FIG. 5) is displayed on the liquid crystal display panel 2, and the second barrier patterns 10B (FIG. 6B) is formed by the switching liquid crystal panel 1.

In FIGS. 7A and 7B, the right eye 10R of the observer is set as the first viewpoint, and the left eye 10L is set as the second viewpoint. In the first display period T1, the first to fourth viewpoint videos are sequentially assigned to the first to fourth sub pixel groups 41 to 44 in accordance with the first display pattern 20A so as to be displayed on the liquid crystal display panel 2. Such a display is observed through the first barrier pattern 10A (FIG. 6A) formed by the switching liquid crystal panel 1. Accordingly, as illustrated in FIG. 7A, only light transmitted from the sub pixels R1, G1, and B1 that form the first viewpoint video is recognized by the right eye 10R. On the other hand, only light transmitted from the sub pixels R2, G2, and B2 that form the second viewpoint video is recognized by the left eye 10L. Accordingly, in the first display period T1, a stereoscopic image that is based on the first viewpoint video and the second viewpoint video is perceived. FIG. 7A is a schematic diagram illustrating the configuration of a cross-section perpendicular to the screen (XY plane) in an area VIIA surrounded by broken lines illustrated in FIG. 4.

In addition, in the second display period T2 following the first display period T1, the first to fourth viewpoint videos are sequentially assigned to the first to fourth sub pixel groups 41 to 44 in accordance with the second display pattern 20B so as to be displayed on the liquid crystal display panel 2. Such a display is observed through the second barrier pattern 10B (FIG. 6B) formed by the switching liquid crystal panel 1. Accordingly, as illustrated in FIG. 7B, only light transmitted from the sub pixels R1, G1, and B1 that form the first viewpoint video is recognized by the right eye 10R. On the other hand, only light transmitted from the sub pixels R2, G2, and B2 that form the second viewpoint video is recognized by the left eye 10L. Accordingly, also in the second display period T2, a stereoscopic image that is based on the first viewpoint video and the second viewpoint video is perceived. FIG. 7B is a schematic diagram illustrating the configuration of a cross-section perpendicular to the screen (XY plane) in an area VIIB surrounded by broken lines illustrated in FIG. 5.

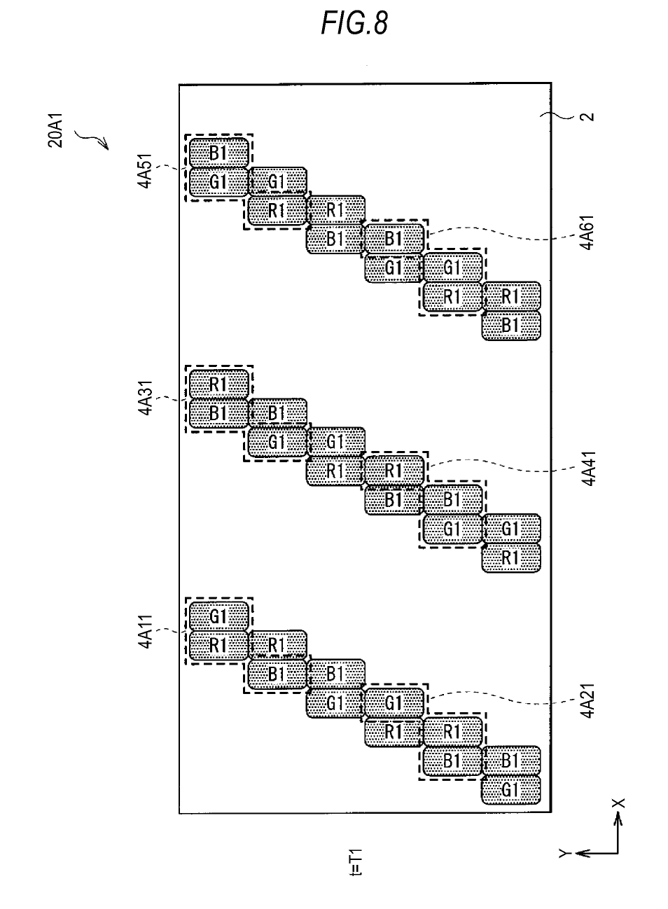

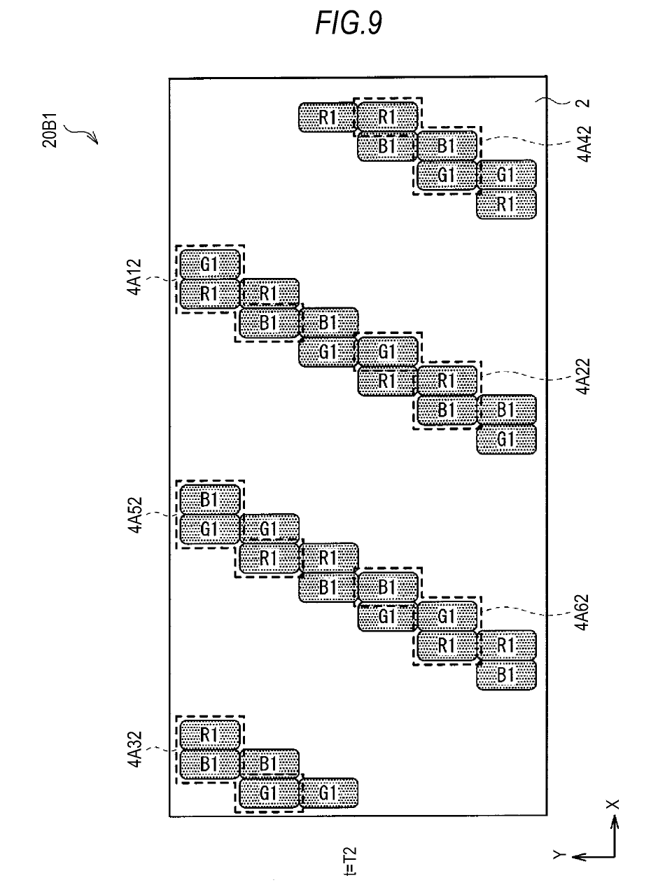

FIG. 8 illustrates an arrangement pattern 20A1 of sub pixels configuring the first viewpoint video that can be visually recognized by the right eye 10R in the first display period T1. On the other hand, FIG. 9 illustrates an arrangement pattern 20B1 of sub pixels configuring the first viewpoint video that can be visually recognized by the right eye 10R in the second display period T2.

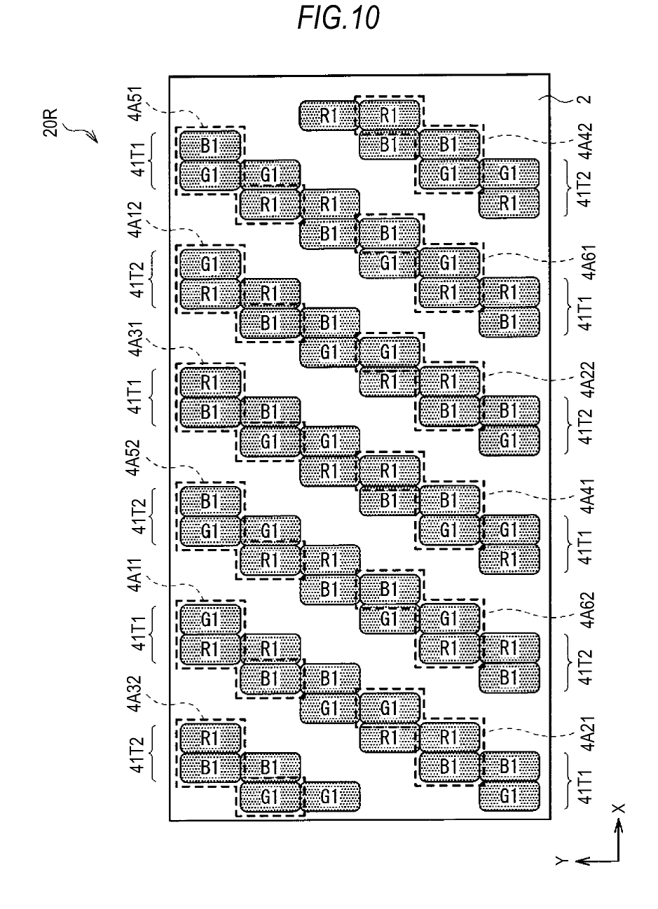

Since the first and second display periods T1 and T2 are extremely short, the arrangement pattern 20A1 and the arrangement pattern 20B1 are recognized as one video overlapping each other by the observer. In other words, as illustrated in FIG. 10, a composite video 20R that is acquired by composing the arrangement pattern 20A1 of the sub pixels illustrated in FIG. 8 and the arrangement pattern 20B1 of the sub pixels illustrated in FIG. 9 is recognized by the observer as the first viewpoint video acquired from the right eye 10R. In addition, as illustrated in FIG. 10, a sub pixel group 41T1 displayed in one arrangement pattern 20A is positioned between sub pixel groups 41T2 displayed in the other display pattern 20B on the liquid crystal display panel 2. Particularly, the sub pixel groups 41T1 of the arrangement pattern 20A1 and the sub pixel groups 41T2 of the arrangement pattern 20B1 are arranged such that gaps therebetween are the same. Here, the unit pixels that correspond to each other in the arrangement pattern 20A1 and the arrangement pattern 20B1 are disposed at positions overlapping each other when being relatively moved in parallel in the screen horizontal direction. For example, a relation is formed such that, by moving pixels 4A11, 4A21, 4A31, 4A41, 4A51, and 4A61 of the arrangement pattern 20A1 in the screen horizontal direction by 12 sub pixels, the pixels overlap pixels 4A12, 4A22, 4A32, 4A42, 4A52, and 4A62 of the arrangement pattern 20B1 (see FIGS. 8 to 10).

As illustrated in FIG. 10, in the composite video 20R, through the first display period T1 and the second display period T2, as a result, the first viewpoint video is displayed by using a half of the total sub pixels disposed on the liquid crystal display panel 2. Accordingly, the spatial resolution of the display of the first viewpoint video is improved to be double the resolution of a case where a time-divisional display is not performed (a case where the first viewpoint video is displayed in a space divisional manner in accordance with only one display pattern). Here, since the unit pixels of the arrangement pattern 20A1 and the arrangement pattern 20B1 that correspond to each other are present at positions that are relatively moved from each other in parallel in the screen horizontal direction, the resolution of the first viewpoint video in the screen horizontal direction is improved to be doubled.

In addition, since each one of the unit pixels is configured by sub pixels R, G, and B of three types of colors that are selected from two consecutive rows extending in the screen horizontal direction, the deterioration of the resolution in the screen vertical direction is less than that of a case where each one of the unit pixels is configured by sub pixels R, G, and B aligned in one row in the diagonal direction.

In this embodiment, the first viewpoint video is observed by the right eye 10R, and the second viewpoint video is observed by the left eye 10L, whereby a stereoscopic image is perceived. However, a stereoscopic image can be observed by arbitrarily combining any two of the first to fourth viewpoint videos.

### Advantages of First Embodiment

As above, according to this embodiment, the first to fourth viewpoint videos that are spatially divided are composed within one screen by sequentially displaying the first and second display patterns 20A and 20B that are divided in time. Accordingly, compared to a case where each viewpoint video is displayed in a space divisional manner by using only one display pattern, the resolution of the stereoscopic display can be improved. Here, of the first and second display patterns 20A and 20B, since the unit pixels configuring each viewpoint video are present at positions that are relatively moved from each other in parallel in the screen horizontal direction, the resolution of each viewpoint video in the horizontal direction can be further improved. In addition, since one unit pixel 4 is configured by the sub pixels R, G, and B of three types of colors selected from two consecutive rows extending in the screen horizontal direction, deterioration of the resolution in the screen vertical direction is suppressed. As a result, a high-precision stereoscopic video can be displayed while improving a balance between the resolution in the screen horizontal direction and the resolution in the screen vertical direction.

### Second Embodiment

Next, a stereoscopic display device according to a second embodiment of the present disclosure will be described. The same reference numeral is assigned to a constituent portion that is substantially the same as that of the stereoscopic display device according to the above-described first embodiment, and the description thereof will be appropriately omitted.

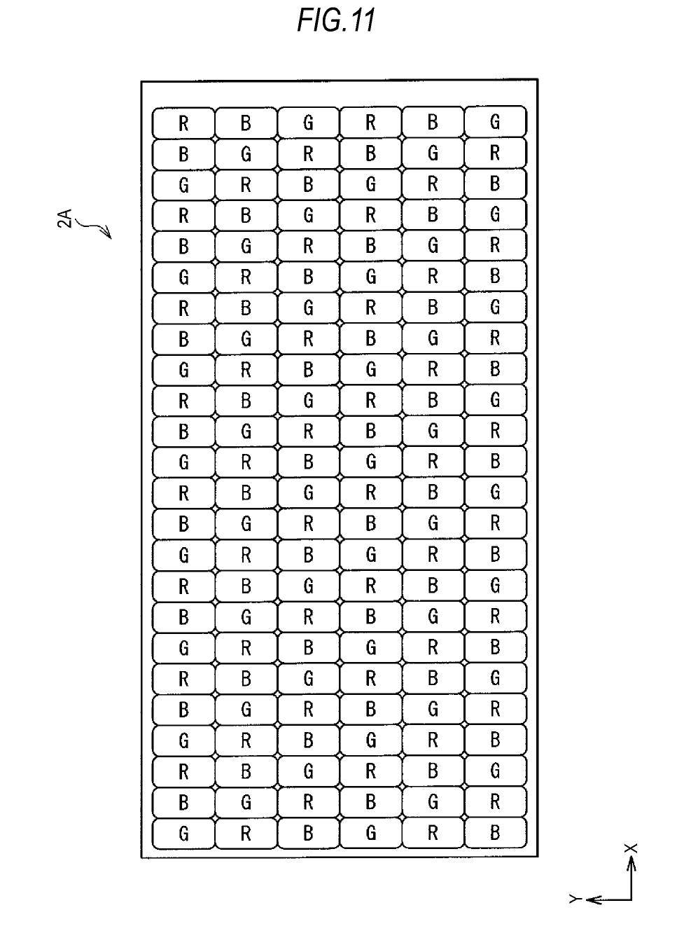

In the above-described first embodiment, on the liquid crystal display panel 2, the pixel arrangement is formed such that sub pixels of different colors periodically appear in the same row in the screen horizontal direction, and sub pixels of the same color are aligned in the same row in the screen vertical direction. In contrast to this, according to this embodiment, as illustrated in FIG. 11, a liquid crystal display panel 2A having a pixel arrangement is used in which sub pixels of different colors periodically appear in the same row in the screen horizontal direction and the same row in the screen vertical direction, and sub pixels of the same color are aligned in the same row in the screen diagonal direction. FIG. 11 illustrates an example of the pixel arrangement of the liquid crystal display panel 2A of the stereoscopic display device according to this embodiment.

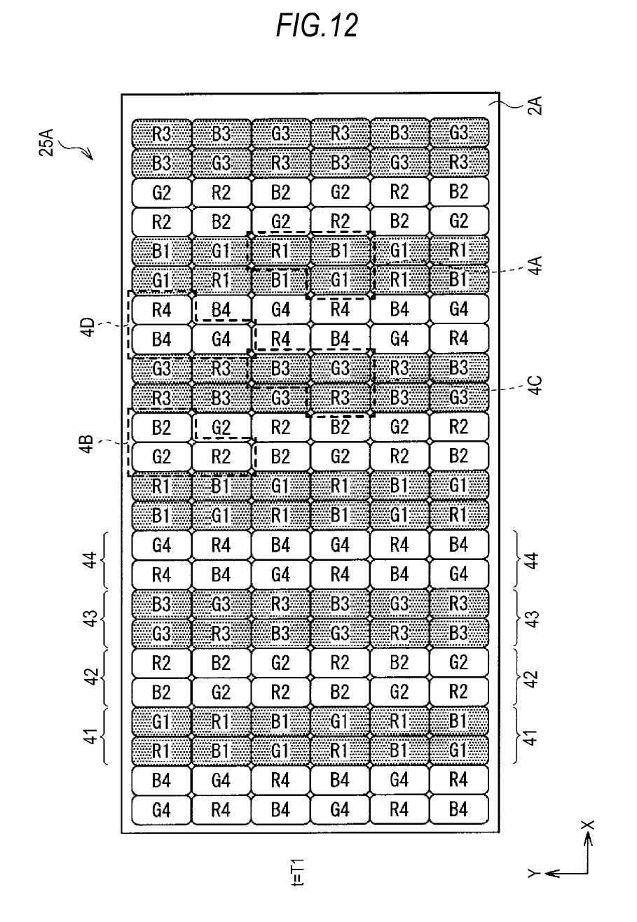

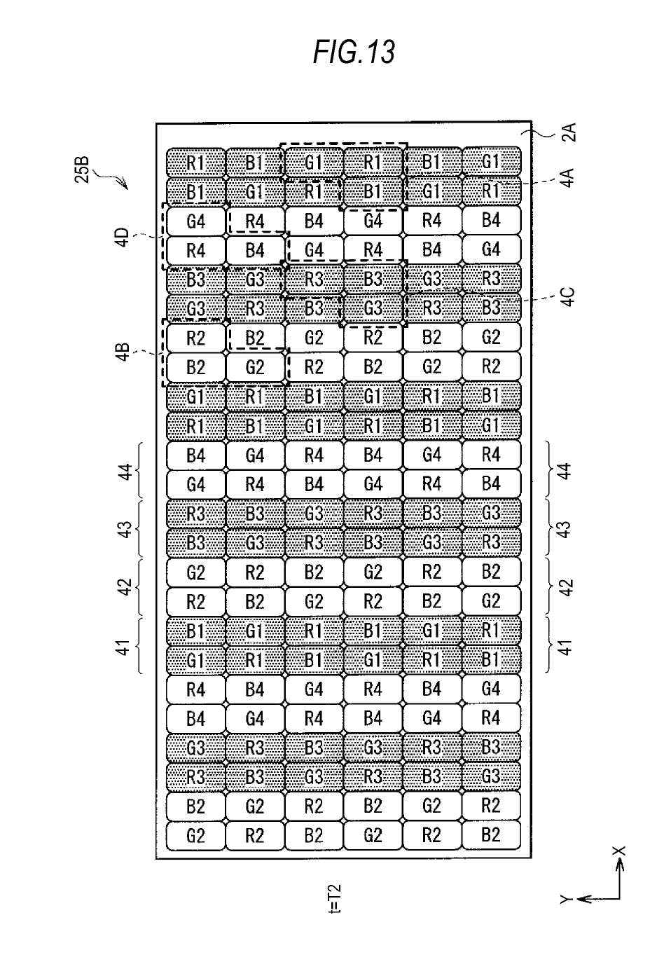

FIGS. 12 and 13 illustrate first and second display patterns 25A and 25B as an example of the two types of display patterns that are displayed in a time-divisional manner on the liquid crystal display panel 2A. In the first and second display patterns 25A and 25B, first to fourth sub pixel groups 41 to 44 extend in the screen vertical direction and are periodically arranged sequentially in the screen horizontal direction. The first sub pixel group 41 includes two consecutive sub pixel rows that are formed from a plurality of sub pixels R1, G1, and B1 aligned in the screen vertical direction. Similarly, the second sub pixel group 42 includes two consecutive sub pixel rows that are formed from a plurality of sub pixels R2, G2, and B2 aligned in the screen vertical direction. The third sub pixel group 43 includes two consecutive sub pixel rows that are formed from a plurality of sub pixels R3, G3, and B3 aligned in the screen vertical direction. The fourth sub pixel group 44 includes two consecutive sub pixel rows that are formed from a plurality of sub pixels R4, G4, and B4 aligned in the screen vertical direction. The first to fourth sub pixel groups 41 to 44 display the first to fourth viewpoint videos. In FIGS. 12 and 13, for easy identification, hatching is applied to the sub pixel rows of the first and third sub pixel groups 41 and 43 for convenience sake.

Here, one unit pixel that displays each one of the first to fourth viewpoint videos is configured by sub pixels of three colors R, G, and B selected from two consecutive rows extending in the screen horizontal direction. For example, as illustrated in FIGS. 12 and 13, a unit pixel 4A that displays the first viewpoint video (for example, a video for the right eye) is configured by a sub pixel G1 and a sub pixel B1 that are arranged in the same row extending in the screen horizontal direction and a sub pixel R1 that is present in a row adjacent to the row. Similarly, sub pixels R2, G2, and B2 are constituent elements of a unit pixel 4B that displays the second viewpoint video (for example, a video for the left eye). In addition, a unit pixel 4C that is configured by sub pixels R3, G3, and B3 configures the third viewpoint video, and a unit pixel 4D that is configured by sub pixels R4, G4, and B4 configures the fourth viewpoint video. As a result, the stripe-shaped first to fourth viewpoint videos extending in the screen vertical direction are periodically arranged in the screen horizontal direction.

In the first display pattern 25A illustrated in FIG. 12 and the second display pattern 25B illustrated in FIG. 13, the positions of the unit pixels displaying the first to fourth viewpoint videos are different from each other. For example, the unit pixel 4A that is formed by the sub pixels R1, G1, and B1 to which the first viewpoint video is assigned in the first display pattern 25A becomes the unit pixel 4C formed from the sub pixels R3, G3, B3 to which the third viewpoint video is assigned in the second display pattern 25B. Similarly, the unit pixels 4B, 4C, and 4D to which the second, third, and fourth viewpoint videos are assigned in the first display pattern 25A become the unit pixels 4D, 4A, and 4B to which the fourth, first, and second viewpoint videos are assigned in the second display pattern 25B.

### [Operation of Stereoscopic Display Device]

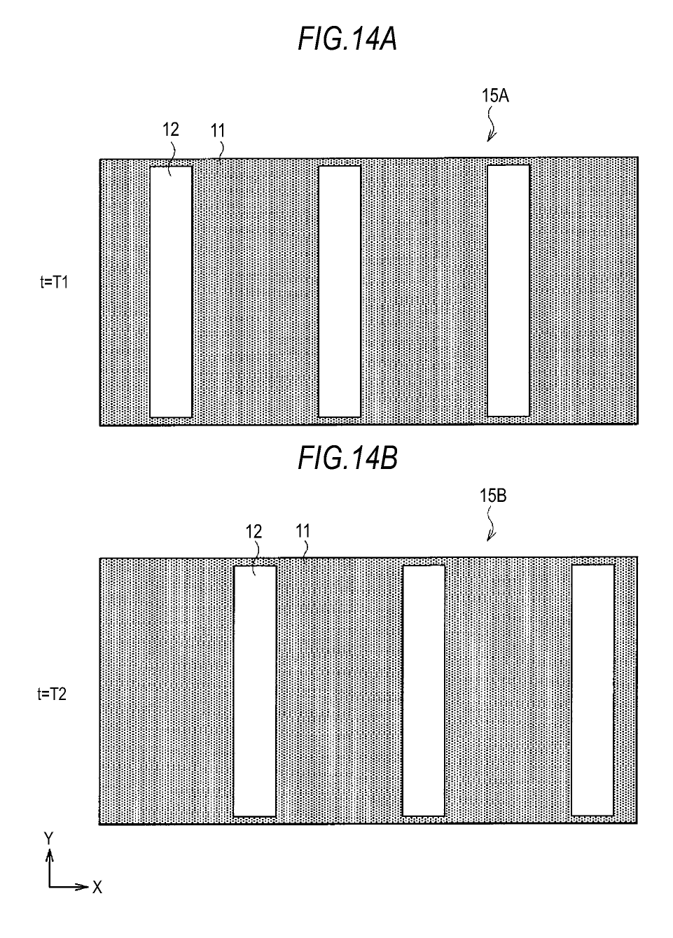

According to the stereoscopic display device of this embodiment, similarly to the above-described first embodiment, a stereoscopic view can be formed. In other words, on the liquid crystal display panel 2A, each viewpoint video is displayed in the first and second display patterns 25A and 25B within one screen in a spatially divided manner, and the first and second display patterns 25A and 25B are periodically changed so as to be displayed. In addition, on the switching liquid crystal panel 1, first and second barrier patterns 15A and 15B illustrated in FIGS. 14A and 14B are periodically formed so as to enable a stereoscopic view in synchronization with the switching between the first and second display patterns 25A and 25B.

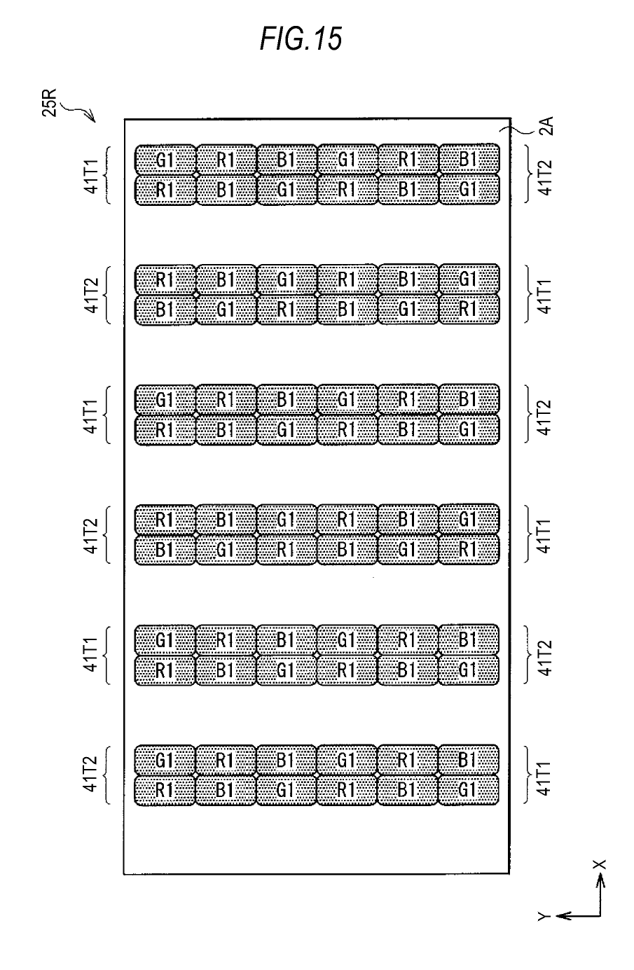

FIG. 15 illustrates a composite image 25R of the arrangement pattern of sub pixels configuring the first viewpoint video visually recognized by the right eye 10R in the first display period T1 and the arrangement pattern of sub pixels configuring the first viewpoint video visually recognized by the right eye 10R in the second display period T2. As illustrated in FIG. 15, also in the liquid crystal display panel 2A, a sub pixel group 41T1 displayed in the first display period T1 is positioned between sub pixel groups 41T2 displayed in the second display period T2. Particularly, the sub pixel groups 41T1 and the sub pixel groups 41T2 are arranged such that gaps therebetween are the same. Here, the unit pixels that correspond to each other in the sub pixel group 41T1 and the sub pixel group 41T2, similarly to the first embodiment, are disposed at positions overlapping each other when being relatively moved in parallel in the screen horizontal direction.

As illustrated in FIG. 15, also in the composite video 25R, through the first display period T1 and the second display period T2, as a result, the first viewpoint video is displayed by using a half of the total sub pixels disposed on the liquid crystal display panel 2. Accordingly, the spatial resolution of the display of the first viewpoint video is improved to be double the resolution of a case where a time-divisional display is not performed (a case where the first viewpoint video is displayed in a space divisional manner in accordance with only one display pattern). Here, since the unit pixels of the sub pixel group 41T1 and the sub pixel group 41T2 that correspond to each other are present at positions that are relatively moved from each other in parallel in the screen horizontal direction, the resolution of the first viewpoint video in the screen horizontal direction is improved to be doubled.

In addition, since each one of the unit pixels is configured by sub pixels R, G, and B of three types of colors that are selected from two consecutive rows extending in the screen horizontal direction, the deterioration of the resolution in the screen vertical direction is less than that of a case where each one of the unit pixels is configured by sub pixels R, G, and B aligned in one row in the diagonal direction.

### Advantages of Second Embodiment

As described above, according to this embodiment, a high-precision stereoscopic video can be displayed while improving a balance between the resolution in the screen horizontal direction and the resolution in the screen vertical direction.

### EXAMPLES

Specific examples of the present disclosure will be described in detail.

Generally, according to the step barrier system, there are cases where, while the resolution balance at a specific number of viewpoints is improved, it is difficult to acquire sufficient resolution balance at the other numbers of viewpoints. For example, in the case of a stripe-shaped viewpoint video that is formed by sub pixels of a plurality of colors aligned in one row in the diagonal direction and is spatially divided, compared to the original two-dimensional display image, resolution deterioration as illustrated in the following Equations (1) and (2) occurs. Here, C denotes the number of types of colors of sub pixels, RV denotes a resolution deterioration index in the vertical direction, RH denotes a resolution deterioration index in the horizontal direction, and OP denotes the number of viewpoints. Here, a two-dimensional display panel is assumed to have a configuration in which sub pixels of the same color are aligned in the vertical direction, and sub pixels of different colors are sequentially aligned in the horizontal direction in a repetitive manner.

RV=1/C (1)

RH=C/OP (2)

Here, when the resolution balance index K is defined as Equation (3), in a case where the resolution deterioration index RV in the vertical direction and the resolution deterioration index RH in the horizontal direction are the same, in other words, in a case where K=0, the best resolution balance is acquired. It can be stated that the resolution balance deteriorates as the resolution balance index K increases.

K=|log(RH/RV)| (3)

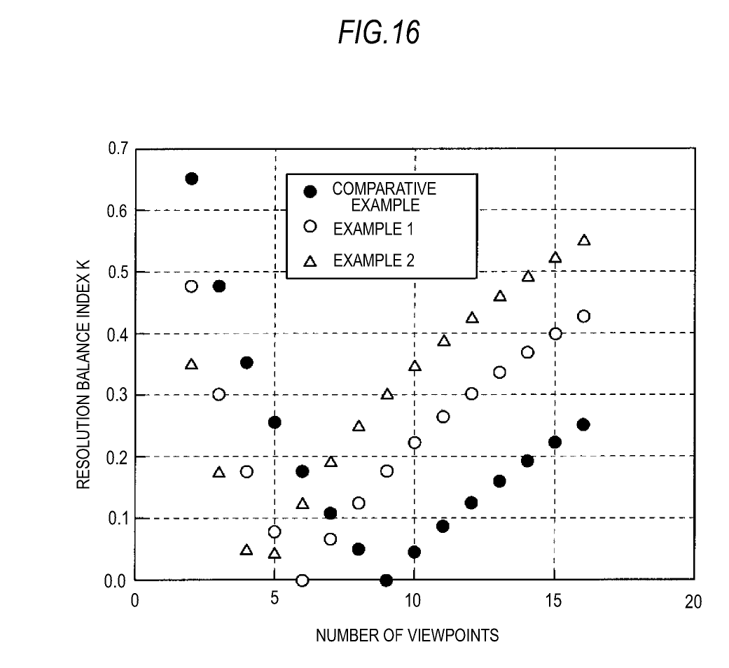

Thus, in this example, in a case where a stereoscopic display video is displayed by sub pixels of three colors, a change in the resolution balance from that of the original two-dimensional display image is calculated. More specifically, changes in the resolution balance index K according to the number of viewpoints are acquired for a comparative example, Example 1, and Example 2 that satisfy the following conditions. The results are illustrated in FIG. 16. In addition, in display patterns that are divided in time, unit pixels corresponding to each other are configured so as to be located at positions overlapping each other when being relatively moved in parallel in the screen horizontal direction.

### Comparative Example

### Case where Only Space-Divisional Display is Performed, and Each Unit Pixel is Configured by Sub Pixels Located in Different Rows

### Example 1

### Case where Only Space-Divisional Display is Performed, and Two Sub Pixels Configuring Each Unit Pixel are Selected from the Same Row Extending in the Screen Horizontal Direction

### Example 2

### Case where Time-Division Display Corresponding to the Number of Viewpoint Videos (the Number of Viewpoints) is Performed Together with Space-Divisional Display, and Two Sub Pixels Configuring Each Unit Pixel are Selected from the Same Row Extending in the Screen Horizontal Direction

The resolution deterioration index RV in the vertical direction was ⅓ for the comparative example and was ⅔ for Embodiments 1 and 2. In addition, the resolution deterioration index RH in the horizontal direction can be acquired by using Equation (2) described above.

As illustrated in FIG. 16, in the comparative example, a complete resolution balance can be acquired in a case where the number of viewpoints is nine, and as the number of viewpoints becomes farther from nine, the resolution balance index K further increases (in other words, the resolution balance deteriorates). In contrast to this, according to Example 1, the resolution balance is improved, compared to the comparative example, when the number of viewpoints is in the range of two to seven. In addition, according to Example 2, the resolution balance is improved, compared to the comparative example, when the number of viewpoints is in the range of two to six.

As above, the embodiments of the present disclosure have been described. However, the present disclosure is not limited to the above-described embodiments, and various changes can be made therein. For example, in the above-described embodiments, a case has been described in which the unit pixel of the two-dimensional display unit is configured by sub pixels of three colors R (red), G (green), and B (blue). However, in the embodiment of the present disclosure, the unit pixel may be configured by sub pixels of four or more colors (a combination of R (red), G (green), B (blue), and W (white) or Y (yellow)).

In addition, in the above-described embodiments, a case where two display patterns, in which two viewpoint videos are divided in time, are sequentially displayed on the display unit (the liquid crystal display panel) has been described. However, in the embodiment of the present disclosure, the number of viewpoint videos and the number of display patterns are not limited thereto and may be respectively an integer equal to or greater than two. In other words, the display unit according to a first stereoscopic display device and a first stereoscopic display method of the embodiment of the present disclosure composes p (here, p is an integer equal to or greater than two) viewpoint videos that are spatially divided within one screen by sequentially displaying q (here, q is an integer that is equal to or greater than two and is equal to or less than p) display patterns that are divided in time. Accordingly, it is preferable that the variable-type parallax barrier as the optical separation device according to the first stereoscopic display device and the first stereoscopic display method of the embodiment of the present disclosure is configured such that arrangement states of a plurality of light transmitting portions and a plurality of light shielding portions can be changed in accordance with the q display patterns, and the p viewpoint videos configuring each one of the q display patterns displayed on the display unit is optically separated so as to enable a stereoscopic view at the p viewpoints. At this time, it is preferable that the q display patterns be formed by displaying two consecutive sub pixel rows formed from the plurality of the sub pixels aligned in the first direction (the screen diagonal direction or the screen vertical direction) a plurality of times at a period of (p×2) rows in the screen horizontal direction, and each one of the unit pixels is configured by r types of the sub pixels selected from two or more and (r−1) or less consecutive rows extending in the screen horizontal direction.

In addition, in the above-described embodiments, a case has been described in which the resolution in the horizontal direction is improved by sequentially displaying two display patterns in which the plurality of viewpoint videos are divided in time. However, the present disclosure represents a concept that includes a case where such a time-division display is not performed. In other words, in a second stereoscopic display device and a second stereoscopic display method of the embodiment of the present disclosure, it is preferable that the two-dimensional display unit display p (here, p is an integer equal to or greater than two) viewpoint videos. Accordingly, in the second stereoscopic display device and the second stereoscopic display method of the embodiments of the present disclosure, it is preferable that the optical separation device optically separate the p viewpoint videos displayed on the two-dimensional display unit such that a stereoscopic view at the p viewpoints can be formed. At this time, it is preferable that the p viewpoints videos be formed by displaying two consecutive sub pixel rows formed from the plurality of the sub pixels aligned in the first direction a plurality of times at a period of (p×2) rows in the screen horizontal direction, and one of the unit pixels is configured by r types of the sub pixels selected from two or more and (r−1) or less consecutive rows extending in the screen horizontal direction. According to the second stereoscopic display device and the second stereoscopic display method of the embodiments of the present disclosure, compared to a case where each one of the unit pixels is configured by sub pixels R, G, and B aligned in one row in the diagonal direction, the deterioration of the resolution in the screen vertical direction can be suppressed. Accordingly, by appropriately selecting the types of colors of the sub pixels and the number of the viewpoint videos, a balance between the resolution in the screen vertical direction and the resolution in the screen horizontal direction can be improved.

In addition, in the above-described embodiments, the variable-type parallax barrier as the optical separation device, the liquid crystal display panel as the two-dimensional display unit, and the back light as the light source are sequentially arranged from the observer side. However, the present disclosure is not limited thereto, and for example, the two-dimensional display unit, the optical separation device, and the light source may be sequentially arranged from the observer side. In such a case, as the two-dimensional display unit, for example, a transmissive-type liquid crystal display may be used.

Furthermore, in the above-described embodiments, a color liquid crystal display using the back light as the two-dimensional display unit has been described as an example. However, the present disclosure is not limited thereto. For example, a display using an organic EL device or a plasma display may be used.

In addition, in the above-described embodiments, although the shape of the opening in the barrier pattern is configured as a step shape, the present disclosure is not limited thereto. For example, the shape of the opening may be a stripe shape extending in the diagonal direction.

Furthermore, in the above-described embodiments, although the variable-type parallax barrier is used as the optical separation device, the present disclosure is not limited thereto. For example, a liquid crystal lens or a lenticular lens that applies an optical operation for transmitted light may be used as the optical separation device. The liquid crystal lens is formed by inserting a liquid crystal layer between one pair of transparent electrode substrates arranged so as to face each other with a predetermined gap interposed therebetween, and switching can be electrically performed between a state in which there is no lens effect and a state in which there is a lens effect in accordance with the state of a voltage applied between the one pair of transparent electrode substrates. Here, by appropriately adjusting the application voltage in the in-plane direction in accordance with a display pattern displayed on the display unit, the same effect as that of the variable-type parallax barrier can be acquired. The lenticular lens is formed by aligning a plurality of cylindrical lenses in one-dimensional direction. By changing the position of the lenticular lens in the screen horizontal direction with respect to the display unit, the same effect as that of the variable-type parallax barrier can be acquired.

The present disclosure contains subject matter related to that disclosed in Japanese Priority Patent Application JP 2010-234799 filed in the Japan Patent Office on Oct. 19, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display unit that composes p (here, p is an integer equal to or greater than two) viewpoint videos that are spatially divided within one screen by sequentially displaying q (here, q is an integer that is equal to or greater than two and is equal to or less than p) display patterns that are divided in time; and
an optical separation device that optically separates the p viewpoint videos configuring each one of the q display patterns displayed on the display unit,
wherein the display unit includes a plurality of unit pixels each formed from a plurality of sub pixels displaying r types (here, r is an integer equal to or greater than three) of colors necessary for a color video display, the sub pixels of different colors are arranged in a same row in a screen horizontal direction and in a same row in a first direction other than the screen horizontal direction, and the sub pixels of a same color are arranged in a same row in a second direction other than both the screen horizontal direction and the first direction,
wherein the q display patterns are formed by displaying two consecutive sub pixel rows formed from the plurality of the sub pixels aligned in the first direction a plurality of times at a period of (p×2) rows in the screen horizontal direction,
wherein each one of the unit pixels is configured by r types of the sub pixels selected from two or more and (r−1) or less consecutive rows extending in the screen horizontal direction, and
wherein the q display patterns composed within one screen are disposed at positions for which the unit pixels corresponding to each other overlap each other when the display patterns are relatively moved in parallel in the screen horizontal direction.

2. The display device according to claim 1, wherein the unit pixel is formed from the sub pixels of three colors R (red), G (green), and B (blue), the sub pixels of two colors out of the sub pixels of the three colors are present in a same row in the screen horizontal direction, and the sub pixels of a remaining one color are present in a row that is adjacent to the rows in which the sub pixels of the two colors are present.

3. The display device according to claim 1,
wherein there are three types (r=3) of colors of the sub pixels, and
wherein the number of the viewpoint videos is twice the number of the display patterns and is an integer that is equal to or greater than two and is equal to or less than six.

4. The display device according to claim 1, wherein the optical separation device is a variable-type parallax barrier that includes a plurality of light transmitting portions that transmit light output from the display unit or light traveling toward the display unit and a plurality of light shielding portions that shield the light output from the display unit or the light traveling toward the display unit and is configured such that arrangement states of the plurality of light transmitting portions and the plurality of light shielding portions can be changed in accordance with the q display patterns.

5. The display device according to claim 4, wherein the plurality of light transmitting portions of the variable-type parallax barrier have a step shape or a stripe shape that extends in a diagonal direction in accordance with the two consecutive sub pixel rows.

6. The display device according to claim 1, wherein a time interval at which the q display patterns are displayed is equal to or less than 1/60 seconds.

7. The display device according to claim 1, wherein the first direction is a screen diagonal direction, and the second direction is a screen vertical direction.

8. The display device according to claim 1, wherein the first direction is a screen vertical direction, and the second direction is a screen diagonal direction.

9. A display device comprising:
a display unit that displays p (here, p is an integer equal to or greater than two) viewpoint videos; and
an optical separation device that optically separates the p viewpoint videos displayed on the display unit such that a stereoscopic view at the p viewing points can be formed,
wherein the display unit includes a plurality of unit pixels each formed from a plurality of sub pixels displaying r types (here, r is an integer equal to or greater than three) of colors necessary for a color video display, the sub pixels of different colors are arranged in a same row in a screen horizontal direction and in a same row in a first direction other than the screen horizontal direction, and the sub pixels of a same color are arranged in a same row in a second direction other than both the screen horizontal direction and the first direction,
wherein the p viewpoints videos are formed by displaying two consecutive sub pixel rows formed from the plurality of the sub pixels aligned in the first direction a plurality of times at a period of (p×2) rows in the screen horizontal direction, and
wherein each one of the unit pixels is configured by r types of the sub pixels selected from two or more and (r−1) or less consecutive rows extending in the screen horizontal direction.

10. The display device according to claim 9, wherein the optical separation device is a parallax barrier that includes a plurality of light transmitting portions that transmit light output from the display unit or light traveling toward the display unit and a plurality of light shielding portions that shield the light output from the display unit or the light traveling toward the display unit.

11. A display device comprising:
a display unit that sequentially displays p (here, p is an integer equal to or greater than two) viewpoint videos that are spatially divided in q (here, q is an integer that is equal to or greater than two and is equal to or less than p) display patterns that are divided in time; and
an optical separation device that optically separates the p viewpoint videos,
wherein the display unit includes a plurality of unit pixels each formed from r types (here, r is an integer equal to or greater than three) of sub pixels selected from two or more and (r−1) or less consecutive rows extending in a screen horizontal direction, and
wherein the q display patterns are disposed at positions for which the unit pixels corresponding to each other overlap each other when the display patterns are relatively moved in parallel in the screen horizontal direction.

12. A display device comprising:
a display unit that displays a plurality of viewpoint videos that are spatially divided; and
an optical separation device that optically separates the plurality of viewpoint videos,
wherein the display unit includes a plurality of unit pixels each includes three sub pixels selected from two consecutive rows extending in a screen horizontal direction, and
wherein the plurality of viewpoint videos are disposed at positions for which the unit pixels corresponding to each other overlap each other when the viewpoint videos are relatively moved in parallel in the screen horizontal direction.

13. A display method comprising:
composing p (here, p is an integer equal to or greater than two) viewpoint videos that are spatially divided within one screen of a display unit by sequentially displaying q (here, q is an integer that is equal to or greater than two and is equal to or less than p) display patterns that are divided in time; and
optically separating the p viewpoint videos configuring each one of the q display patterns displayed on the display unit by using an optical separation device,
wherein a unit is used as the display unit in which a plurality of unit pixels each formed from a plurality of sub pixels displaying r types (here, r is an integer equal to or greater than three) of colors necessary for a color video display are included, the sub pixels of different colors are arranged in a same row in a screen horizontal direction and in a same row in a first direction other than the screen horizontal direction, and the sub pixels of a same color are arranged in a same row in a second direction other than both the screen horizontal direction and the first direction,
wherein the q display patterns are formed by displaying two consecutive sub pixel rows formed from the plurality of the sub pixels aligned in the first direction a plurality of times at a period of (p×2) rows in the screen horizontal direction,
wherein each one of the unit pixels is configured by r types of the sub pixels selected from two or more and (r−1) or less consecutive rows extending in the screen horizontal direction, and
wherein the q display patterns are disposed at positions for which the unit pixels corresponding to each other overlap each other when the display patterns are relatively moved in parallel in the screen horizontal direction.

14. The display method according to claim 13, wherein, as the optical separation device, a variable-type parallax barrier is used, which includes a plurality of light transmitting portions that transmit light output from the display unit or light traveling toward the display unit and a plurality of light shielding portions that shield the light output from the display unit or the light traveling toward the display unit and is configured such that arrangement states of the plurality of light transmitting portions and the plurality of light shielding portions can be changed in accordance with the q display patterns.

15. A display method comprising:
displaying p (here, p is an integer equal to or greater than two) viewpoint videos on a display unit; and
optically separating the p viewpoint videos displayed on the display unit by using an optical separation device,
wherein, as the display unit, a unit is used in which a plurality of unit pixels each formed from a plurality of sub pixels displaying r types (here, r is an integer equal to or greater than three) of colors necessary for a color video display are included, the sub pixels of different colors are arranged in a same row in a screen horizontal direction and in a same row in a first direction other than the screen horizontal direction, and the sub pixels of a same color are arranged in a same row in a second direction other than both the screen horizontal direction and the first direction,
wherein the p viewpoints videos are formed by displaying two consecutive sub pixel rows formed from the plurality of the sub pixels aligned in the first direction a plurality of times at a period of (p×2) rows in the screen horizontal direction, and
wherein each one of the unit pixels is configured by r types of the sub pixels selected from two or more and (r−1) or less consecutive rows extending in the screen horizontal direction.

16. The display method according to claim 15, wherein, as the optical separation device, a parallax barrier is used, which includes a plurality of light transmitting portions that transmit light output from the display unit or light traveling toward the display unit and a plurality of light shielding portions that shield the light output from the display unit or the light traveling toward the display unit.
